(19) United States
(12) Patent Application Publication
(10) Pub. No.: US 2017/0329421 A1
(43) Pub. Date: Nov. 16, 2017

(54) ELECTRONIC STYLUS WITH INDICATOR

(71) Applicant: Google Inc., Mountain View, CA (US)

(72) Inventors: Alexander Friedrich Kuscher, San Francisco, CA (US); Omri Amarilio, Palo Alto, CA (US); Katie Leah Roberts-Hoffman, San Jose, CA (US)

(21) Appl. No.: 15/150,957

(22) Filed: May 10, 2016

(51) Int. Cl. G06F 3/038; G06K 9/00; G06F 3/16; G06F 3/0488; G06F 3/0484; G06F 3/0481; G06F 3/041; G06F 3/0354; G06F 3/0346; G06T 11/00; G06F 3/03

(52) U.S. Cl. CPC G06F 3/0383; G06T 11/001; G06K 9/00013; G06F 3/167; G06F 3/04883; G06F 3/04845; G06F 3/0304; G06F 3/04817; G06F 3/0416; G06F 3/0414; G06F 3/03545; G06F 3/0346; G06F 3/04842

(57) ABSTRACT

An electronic stylus may comprise a location transmitter configured to prompt a computing device to modify a presentation on a display of the computing device at a location near the electronic stylus, an indicator, the indicator being configured to indicate an attribute of a tool used to modify the presentation on the display at the location near the electronic stylus, and a housing supporting the location transmitter and the indicator.

### TECHNICAL FIELD

This description relates to electronic styluses for providing input to computing devices.

### BACKGROUND

Electronic styluses may be used to provide input to computers, enabling a user to provide input to the computer as if drawing on a piece of paper. In drawing applications, the color to which a presentation on a display of the computing device is modified, or a type of tool modifying the presentation, based on proximity of the electronic stylus, may change.

### SUMMARY

An electronic stylus may comprise a location transmitter configured to prompt a computing device to modify a presentation on a display of the computing device at a location near the electronic stylus, an indicator, the indicator being configured to indicate an attribute of a tool used to modify the presentation on the display at the location near the electronic stylus, and a housing supporting the location transmitter and the indicator.

A computing device may comprise a display configured to present images and detect a location of an electronic stylus, at least one processor configured to modify a presentation on the display at a location near the electronic stylus and determine a color to modify the presentation to, and a transmitter configured to send a signal to the electronic stylus, the signal indicating the determined color and prompting the electronic stylus to display the determined color.

A non-transitory computer-readable storage medium comprising instructions stored thereon. When executed by at least one processor, the instructions may be configured to cause a computing device to at least determine a color to which to modify a presentation on a display of the computing device at a location near an electronic stylus, and transmit a color signal to the electronic stylus, the color signal prompting the electronic stylus to display the determined color.

An electronic stylus may comprise means for prompting a computing device to modify a presentation on a display of the computing device at a location near the electronic stylus, means for indicating an attribute of a tool used to modify the presentation on the display at the location near the electronic stylus, and means for supporting the above means.

A computing device may comprise means for presenting images and detect a location of an electronic stylus, means for modifying a presentation on the display at a location near the electronic stylus and determining a color to modify the presentation to, and means for sending a signal to the electronic stylus, the signal indicating the determined color and prompting the electronic stylus to display the determined color.

A non-transitory computer-readable storage medium may comprise means for causing a computing device to at least determine a color to which to modify a presentation on a display of the computing device at a location near an electronic stylus, and means for causing a computing device to transmit a color signal to the electronic stylus, the color signal prompting the electronic stylus to display the determined color.

A computing device may comprise means for determining a color to which to modify a presentation on a display of the computing device at a location near an electronic stylus, and means for transmitting a color signal to the electronic stylus, the color signal prompting the electronic stylus to display the determined color.

The details of one or more implementations are set forth in the accompanying drawings and the description below. Other features will be apparent from the description and drawings, and from the claims.

### BRIEF DESCRIPTION OF THE DRAWINGS

FIG. 1 shows an electronic stylus being used to add marking to a display of a computing device according to an example implementation.

FIG. 2A shows the electronic stylus with a location transmitter according to an example implementation.

FIG. 2B shows the electronic stylus with a visual indicator proximal to the location transmitter according to an example implementation.

FIG. 2C shows the electronic stylus with a visual indicator located on an opposite end portion of the electronic stylus from the location transmitter according to an example implementation.

FIG. 2D shows an end portion of the electronic stylus displaying an icon representing a type of tool according to an example implementation.

FIG. 2E shows the electronic stylus with a touch sensor according to an example implementation.

FIG. 2F shows the electronic stylus with a multicolor touch sensor according to an example implementation.

FIG. 3 is a block diagram of the electronic stylus according to an example implementation.

FIG. 4 is a block diagram of the computing device according to an example implementation.

FIG. 5 shows the electronic stylus projecting an optical beam onto the computing device according to an example implementation.

FIG. 6 shows an example of a computer device and a mobile computer device that can be used to implement the techniques described here.

### DETAILED DESCRIPTION

An electronic stylus may include a visual indicator that indicates a current attribute of a tool which modifies a display of a computing device based on input from the electronic stylus. The attribute may include, for example, a color of the tool, a type of the tool (such as pen, pencil, marker, paint brush, or highlighter), or a thickness of the tool. The indication of the current attribute, such as the color, may easily show the user the attribute of the tool that he or she is using to modify the display. The user may easily see changes to the attribute of the tool modifying the display based on a change to the visual indicator. The inclusion of the visual indicator in the electronic stylus may obviate any need to show the current attribute on the display, allowing the entire display to be used for desired features. The electronic stylus may determine the attribute based on input from the user and transmit to the computing device a signal indicating the determined attribute, or the computing device may determine the attribute and transmit to the electronic stylus a signal indicating the determined attribute.

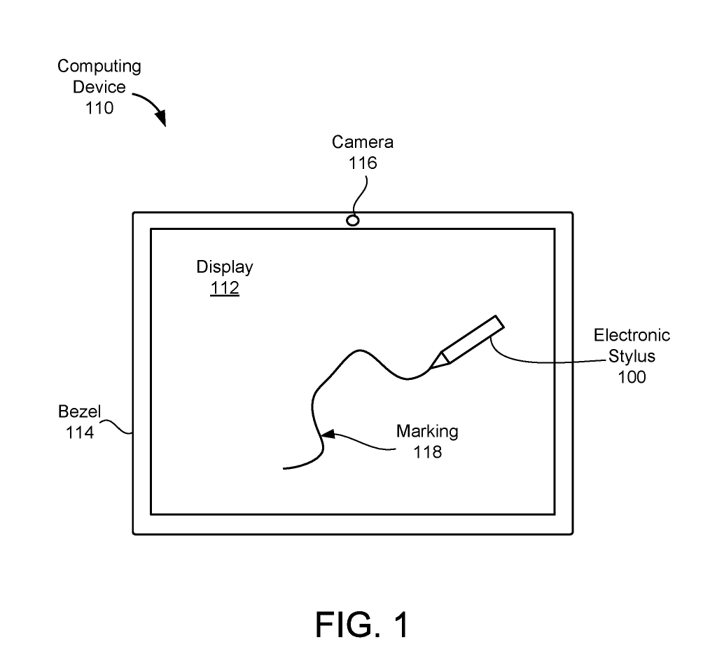

FIG. 1 shows an electronic stylus 100 being used to add marking 118 to a display 112 of a computing device 110 according to an example implementation. The computing device 110 may include a tablet or slate computer, a laptop or notebook computer, or a desktop computer, according to example implementations. The display 112 may present graphical input including displaying images, and may include a light-emitting diode (LED) display, liquid crystal display (LCD), or plasma display, according to example implementations. The display 112 may receive and process input, such as capacitive input or optical input, including infrared input, from the electronic stylus 100, to determine a location and/or pressure of the electronic stylus 100 on the display 112. The display 112 may ignore palm and/or hand input, allowing a user to rest his or her hand on the display 112 while writing on the display 112 with the electronic stylus 100. The display 112 may be surrounded by a bezel 114 which protects the display 112. The computing device 110 may include a camera 116, which may be included in the bezel 114 or be mounted onto the display 112, and which may receive and process optical input.

The electronic stylus 100 may prompt the computing device 110 to modify a presentation on the display 112 at a location near the electronic stylus 100, such as at a location near a location transmitter (shown in subsequent figures) of the electronic stylus 100. The location transmitter may transmit wireless and/or electromagnetic signals, such as in an infrared spectrum, which the computing device 110 may receive and process to determine the location of the location transmitter. The computing device 110 may receive and process the signals when the location transmitter is contacting, or near, the display 112. In a drawing application, for example, the computing device 110 may add marking 118 to the display 112 at locations where the electronic stylus 100 swiped, brushed, or traced onto or near the display 112. The marking 118 may represent pen, pencil, or brush strokes, according to example implementations.

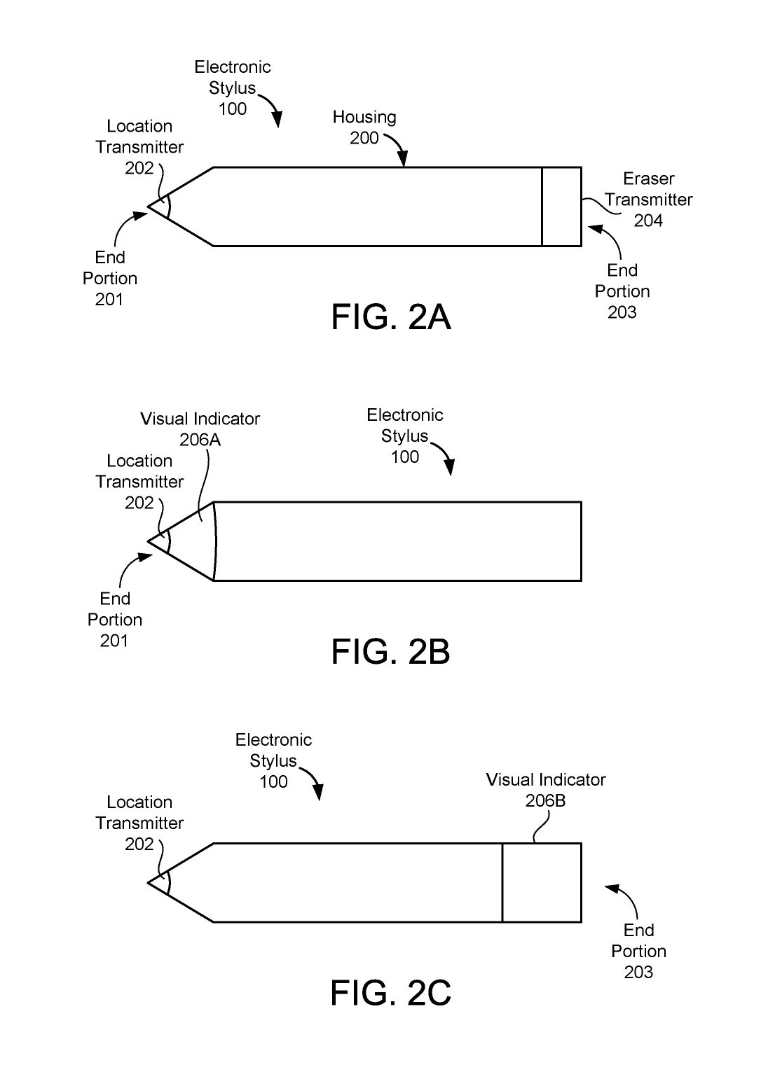

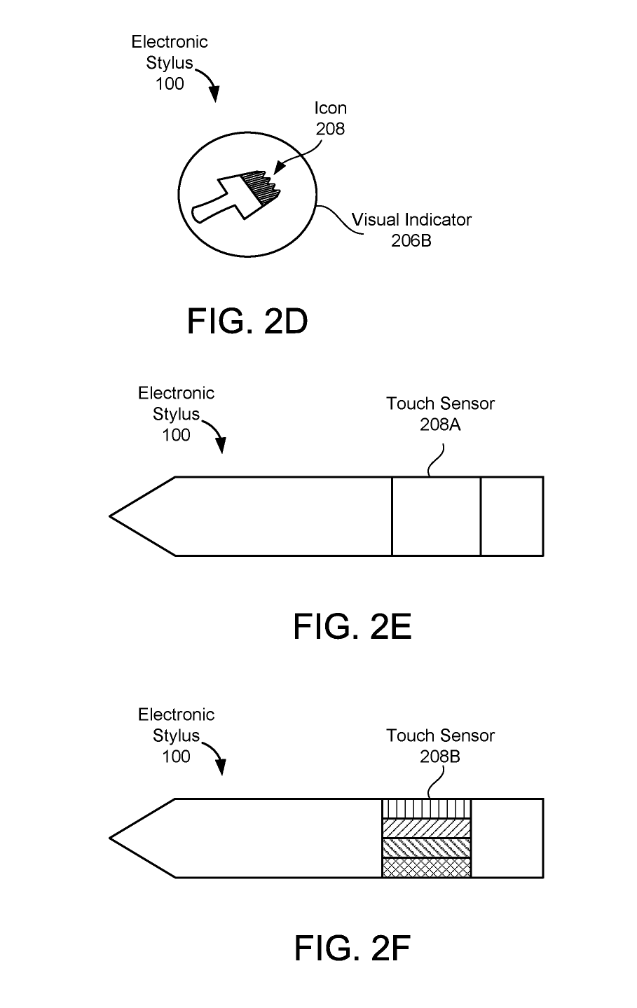

FIG. 2A shows the electronic stylus 100 with a location transmitter 202 according to an example implementation. The electronic stylus 100 may be cylindrical, with a conical end portion 201. The electronic stylus 100 may include a housing 200, which surrounds and/or supports components of the electronic stylus 100 described herein.

The housing 200 may support the location transmitter 202 at the end portion 201 of the electronic stylus 100. The location transmitter 202 may transmit wireless and/or electromagnetic signals, such as infrared signals, that the display 112 (shown in FIG. 1) and computing device 110 (shown in FIG. 1) receive and process to determine which location on the display 112 the electronic stylus 100 is near and/or proximal to. The location transmitter 202 may transmit the signals in a narrow beam, enabling the computing device 110 to determine a specific location that the location transmitter 202 is at or near.

The computing device 110 may modify the presentation on the display 112 at the location that the location transmitter 202 is near and/or proximal to, such as by adding marking 118 (shown in FIG. 1) to the display 112 at locations that the location transmitter 202 is and/or has been near or proximal to.

In an example implementation, the electronic stylus 100 may include an eraser transmitter 204. The eraser transmitter 204 may be located at an opposite end portion 203 from the location transmitter 202. A user may turn the electronic stylus 100 around to erase marking 118 from the display 112.

The eraser transmitter 204 may transmit a location of the eraser transmitter 204, such as by optical output and/or electromagnetic radiation, to the display 112 and/or computing device 110. The eraser transmitter 204 may prompt the computing device 110 to erase marking 118 on the display 112 at a location near the eraser transmitter 204.

FIG. 2B shows the electronic stylus 100 with a visual indicator 206A proximal to the location transmitter 202 according to an example implementation. The visual indicator 206A may include one or more lighting sources, such as light-emitting diodes (LEDs), liquid crystal displays (LCDs), or plasma displays, which are capable of displaying or indicating multiple colors and/or tools.

The visual indicator 206A may be proximal and/or adjacent to the location transmitter 202, or may envelope the location transmitter 202. The proximity of the visual indicator 206A to the location transmitter 202 may cause the end portion 201 to appear to be the color to which the presentation on the display 112 will be modified, similar to an end of a pencil, marker, or paint brush being the color which will be drawn or painted onto a piece of paper or canvas. For example, if red is being drawn onto the display 112, the visual indicator 206A will appear, indicate, and/or display red, and if the color drawn onto the display 112 changes to blue, the visual indicator 206A will change to appearing, indicating, and/or displaying blue.

FIG. 2C shows the electronic stylus 100 with a visual indicator 206B located on an opposite end portion 203 of the electronic stylus 100 from the location transmitter 202 according to an example implementation. The visual indicator 206B may have similar features and/or functionalities as the visual indicator 206A described above with respect to FIG. 2B. The location of the visual indicator 206B at the opposite end portion 203 from the location transmitter 202 may allow the user to easily see the visual indicator 206B indicating the attribute, such as color, of the tool which is modifying the presentation on the display 112, without the user's hand and/or fingers obstructing the user's view of the visual indicator 206B. The electronic stylus 100 may include a visual indicator at locations other than either end portion 201, 203, such as in a middle portion of the electronic stylus 100.

FIG. 2D shows an end portion of the electronic stylus 100 displaying an icon 208 representing a type of tool according to an example implementation. The icon 208 may be displayed by a tool displayer, which may be included in the visual indicator 206B. The icon 208 may represent a type of tool, such as a paint brush, pencil, or marker, or a cursor, which modifies the presentation on the display 112 based on input from the electronic stylus 100.

FIG. 2E shows the electronic stylus 100 with a touch sensor 208A according to an example implementation. The touch sensor 208A may form a band around the electronic stylus 100, and may be supported by the housing 200. The user may provide input to the electronic stylus 100 via the touch sensor 208A, such as by applying pressure to and/or squeezing the touch sensor 208A of the electronic stylus 100, or rubbing and/or stroking the touch sensor 208A of the electronic stylus 100. The touch sensor 208A may include a resistive or capacitive sensor that responds to applications or pressure or proximity of a user's fingers to determine locations and pressures of contacts by the user onto the touch sensor 208A.

In an example implementation, the electronic stylus 100 may determine an attribute such as color and/or type of tool based on the received input to the touch sensor 208A and send to the computing device 110 a signal indicating the determined attribute. In another example implementation, the electronic stylus 100 may send and/or transmit to the computing device 110 the raw touch input data, the computing device 110 may determine, based on the sent and/or transmitted raw touch input data, the attribute, the computing device 110 may send to the electronic stylus 100 a signal indicating the determined attribute, and the electronic stylus 100 may indicate the determined attribute based on the signal received from the computing device 110.

FIG. 2F shows the electronic stylus 100 with a multicolor touch sensor 208B according to an example implementation. The multicolor touch sensor 208B may form a band around the electronic stylus 100. The multicolor touch sensor 208B may concurrently display multiple colors at multiple locations, as shown by the different hatching patterns. The multicolor touch sensor 208B may display the multiple colors by electronic technologies such as LEDs, LCD, or plasma display, or by a color applied to the multicolor touch sensor 208B such as by paint or dye.

The multicolor touch sensor 208B may process touch input in a similar manner as the touch sensor 208A described above with respect to FIG. 2E. The electronic stylus 100 may determine a color attribute based on a location of touch input received by the multicolor touch sensor 208B. The electronic stylus 100 may determine the color to be one of the multiple colors of the multicolor touch sensor 208B at one of the multiple locations, specifically the color of the multicolor touch sensor 208B at the location where the touch input was received. For example, if the user touches a red portion of the multicolor touch sensor 208B, then the electronic stylus 100 will determine the color to be red, whereas if the user touches a blue portion of the multicolor touch sensor 208B, then the electronic stylus 100 will determine the color to be blue. In an example implementation, the location of the multicolor touch sensor 208B with the selected color may change appearance to indicate the color that has been selected, such as by becoming brighter, being surrounded by a specific color such as black, or including text or an icon.

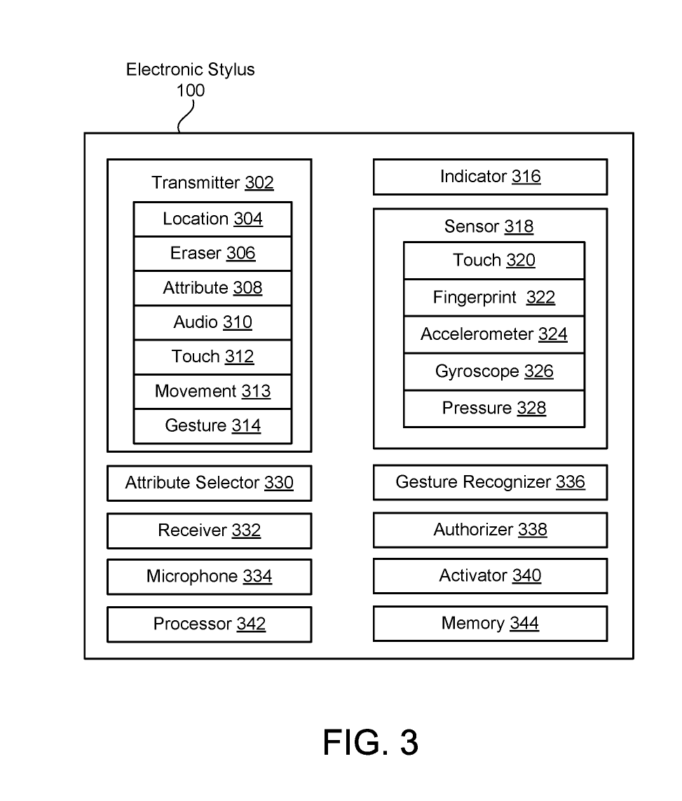

FIG. 3 is a block diagram of the electronic stylus 100 according to an example implementation. The electronic stylus 100 may include any combination of the features of the electronic stylus 100 described above, in combination with any of the features described below.

The electronic stylus 100 may include one or more transmitters 302. The transmitters 302 may transmit signals to the computing device 110 (not shown in FIG. 3). The signals may indicate a location of the electronic stylus 100, an attribute such as color determined by the electronic stylus 100, audio input received by the electronic stylus 100, touch input received by the electronic stylus 100, movement of the electronic stylus 100, and/or a gesture determined or recognized by the electronic stylus 100, according to example implementations.

The electronic stylus 100 may include a location transmitter 304. The location transmitter 304 may transmit a signal based upon which the computing device 110 determines a location of an end portion 201 of the electronic stylus 100, as described above with respect to the location transmitter 202. The computing device 110 may alter a presentation on the display 112 (not shown in FIG. 3) based on the determined location of the end portion 201 of the electronic stylus 100.

The electronic stylus 100 may include an eraser transmitter 306. The eraser transmitter 306 may transmit a signal based upon which the computing device 110 determines a location of an opposite end portion 203 of the electronic stylus 100, as described above with respect to the eraser transmitter 204. The computing device 110 may remove markings 118 from the display 112 based on determined locations of the end portion 203.

The electronic stylus 100 may include an attribute transmitter 308. In an example in which the electronic stylus 100 determines the attribute of the tool which modifies the portion of the display 112 that is near the location transmitter 202, 304, the attribute transmitter 308 may transmit to the computing device 110 a signal indicating the attribute. The computing device 110 may generate subsequent markings 118 with the attribute indicated by the signal sent by the attribute transmitter 308.

The electronic stylus 100 may include an audio transmitter 310. In an example in which the electronic stylus 100 includes a microphone 334 (described below), the audio transmitter 310 may modulate audio input received via the microphone onto a signal, and send the modulated signal to the computing device 110. The audio input may include voice commands, or speech for a presentation, as example implementations.

The electronic stylus 100 may include a touch transmitter 312. The touch transmitter 312 may transmit raw touch data, such as raw touch data received by the touch sensor 208A, 208B described above, or pressure data received by a pressure sensor described below, to the computing device 110. The computing device 110 may determine whether to recognize a gesture or command, or whether to determine an attribute, such as color, based on the touch data received from the touch transmitter 312.

The electronic stylus 100 may include a movement transmitter 313. The movement transmitter 313 may transmit movement data to the computing device 110, based upon which the computing device 110 may interpret gestures to determine commands. The movement data may be received via an accelerator 324, gyroscope 326, and/or pressure sensor 328, described below.

The electronic stylus 100 may include a gesture transmitter 314. In an example in which the electronic stylus 100 determines and/or interprets gestures based on movement and/or pressure data, the gesture transmitter 314 may transmit to the computing device 110 signals indicating determined gestures. The gestures may act as commands to the computing device 110.

The electronic stylus 100 may include an indicator 316. The indicator 316 may indicate an attribute, such as color, to which the presentation on the display 112 will be modified, and/or may indicate a tool with which the presentation will be modified. The indicator 316 may include any of the features and/or functionalities described above with respect to the visual indicator 206A, 206B, icon 208, and/or multicolor touch sensor 208B.

The electronic stylus 100 may include one or more sensors 318. The sensors may receive input from the user. The electronic stylus 100 and/or the computing device 110 may interpret and/or make determinations based on the input, such as determining an attribute, authorizing the user, and/or determining gestures which may be interpreted as commands.

The electronic stylus 100 may include a touch sensor 320. The touch sensor 320 may receive and process touch input, such as squeezing, sliding, or stroking of the touch sensor 320. The touch sensor 320 may include any of the features or functionalities of the touch sensor 208A and/or multicolor touch sensor 308B described above.

The electronic stylus 100 may include a fingerprint sensor 322. The fingerprint sensor 322 may be included in the touch sensor 320, or may be a separate sensor. The fingerprint sensor 322 may receive and/or process inputs from a finger to determine whether a received fingerprint matches a stored fingerprint of an authorized user of the electronic stylus 100.

The electronic stylus 100 may include an accelerometer 324. The accelerometer 324 may determine movement and/or acceleration of the electronic stylus 100. The electronic stylus 100 and/or computing device 110 may determine and/or interpret gestures based on the movement and/or acceleration.

The electronic stylus 100 may include a gyroscope 326. The gyroscope 326 may determine an orientation of the electronic stylus with respect to the ground and/or center of the Earth. The electronic stylus 100 and/or computing device 110 may determine and/or interpret gestures based on the determined orientation, and/or based on the determined orientation, movement, and/or acceleration.

The electronic stylus 100 may include a pressure sensor 328. The pressure sensor 328 may determine and/or measure pressure applied to the electronic stylus 100. The pressure sensor 328 may be included in the touch sensor 320, or may be a separate sensor from the touch sensor 320. The computing device 110 and/or electronic stylus 100 may interpret gestures based on movement, acceleration, and/or orientation data beginning and ending after and before changes to pressure, such as while a user is squeezing the electronic stylus 100, according to an example implementation.

The electronic stylus 100 may include an attribute selector 330. The attribute selector 330 may select and/or determine an attribute, such as color, by which the computing device 110 will modify a presentation on the display 112, and/or the attribute that the indicator 316 should display. The attribute selector 330 may determine the attribute based on a signal received from the computing device 110, or based on input received by the electronic stylus 100, such as input to any of the sensors 318.

The electronic stylus 100 may include a receiver 332. The receiver 332 may receive and/or process signals from the computing device 110, such as signals indicating an attribute such as color that the indicator 316 should indicate and/or display. The receiver 332 may receive and/or process signals from the computing device 110 via a wireless interface and/or protocol, such as Institute for Electrical and Electronics Engineers (IEEE) 802.15 (Bluetooth), or other wireless interfaces and/or wireless communication protocols.

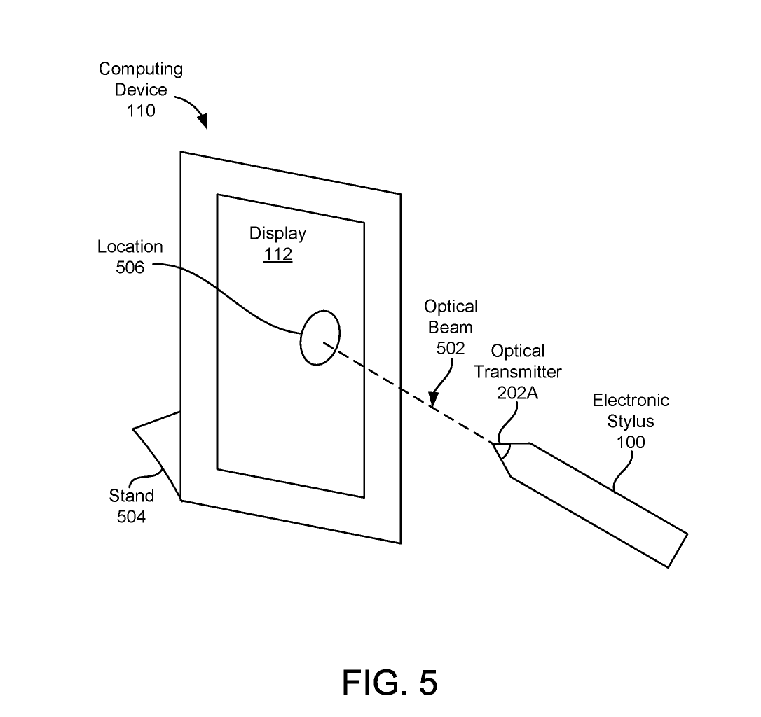

The electronic stylus 100 may include a microphone 334. The microphone may receive audio input, such as a user entering voice commands or speaking for a presentation in which the electronic stylus 100 is used as a microphone and also may be used to provide input to the computing device 110 such as pointing input (described below with respect to FIG. 5).

The electronic stylus 100 may include a gesture recognizer 336. The gesture recognizer may recognize gestures based, for example, on input to the accelerometer 324, gyroscope 326, and/or pressure sensor 328. The gestures may include, for example, mouse clicks, keyboard inputs, and/or predetermined commands.

The electronic stylus 100 may include an authorizer 338. The authorizer 338 may determine whether a user is authorized to use the electronic stylus 100 based, for example, on a fingerprint of the user, a gesture recognized by the electronic stylus, and/or based on a combination of touch inputs to the electronic stylus 100.

The electronic stylus 100 may include an activator 340. The activator 340 may activate the electronic stylus 100 based on input received from the user, such as input that the authorizer 338 recognizes as authorizing the user. The activator 340 may, for example, activate the location transmitter 302, eraser transmitter 306, attribute transmitter 308, audio transmitter 310, touch transmitter 312, movement transmitter 313, and/or gesture transmitter 314 based on authorizing the user. Before the activator 340 has activated the electronic stylus 100, the electronic stylus 100 may not transmit any signals and/or provide any input to the computing device 110, according to an example implementation.

The electronic stylus 100 may include at least one processor 342. The at least one processor 342 may execute instructions, such as instructions stored in memory, to cause the electronic stylus 100 to perform any combination of methods, processes, or functions described herein.

The electronic stylus 100 may include at least one memory device 344. The at least one memory device 344 may include a non-transitory computer-readable storage medium storing instructions and data. The instructions, when executed by the at least one processor 342, may be configured to cause the electronic stylus 100 to perform any combination of methods, processes, or functions described herein. The data may include any data received by any of the sensors 318, transmitted by any of the transmitters 302, received by the receiver 332, and/or generated or acted upon by any component of the electronic stylus 100.

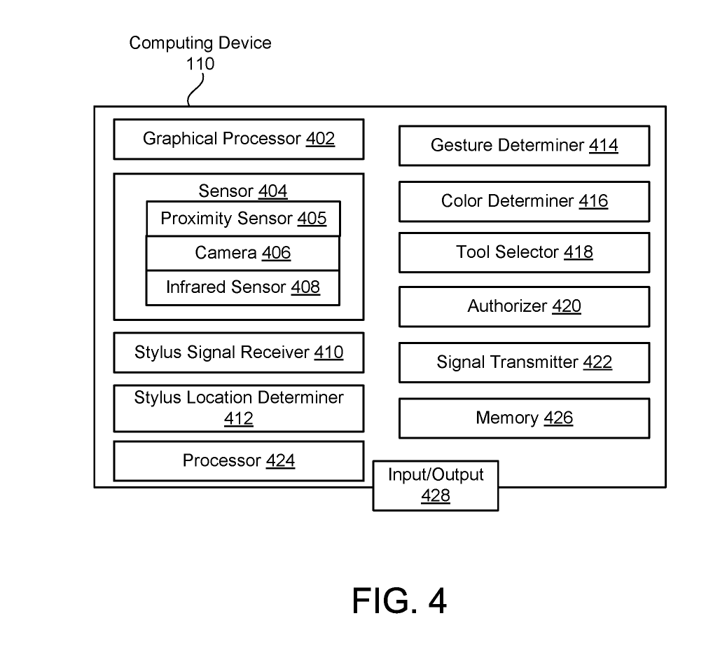

FIG. 4 is a block diagram of the computing device 110 according to an example implementation. The computing device 110 may include any combination of the features of the computing device 110 described above, in combination with any of the feature described below.

The computing device 110 may receive input from the electronic stylus 100 (not shown in FIG. 4), based upon which the computing device 110 determines a location of the electronic stylus 100. The computing device 110 may modify a presentation on the display 112 (not shown in FIG. 4) based on the determined location of the electronic stylus 100, such as showing markings 118 (not shown in FIG. 4), which may be lines, curves, or scribbles along a path of the electronic stylus 100 on or near the display 112.

The computing device 110 may include a graphics processor 402. The graphics processor 402 may generate and/or determine graphical output to present via the display 112. The graphical output may include the markings 118, and may also include color palettes, tool selectors, icons, or text, as non-limiting examples. In an example of a drawing application, the graphical output may be based on a determined location of the electronic stylus 100, a determined tool type, and/or a determined color.

The computing device 110 may include one or more sensors 404. The sensors may generate data to determine a location and/or direction of the electronic stylus 100. The sensors 404 may include an optical sensor which receives and processes optical input, based upon which the computing device 110 may determine the location of the electronic stylus 100 and a direction that the electronic stylus 100 is pointing.

The computing device 110 may include a proximity sensor 405. The proximity sensor may sense a proximity of the location transmitter 202 and/or eraser transmitter 204. The proximity sensor 405 may include a grid of capacitive sensors sensing changes in capacitance caused by proximity of the location transmitter 202 and/or eraser transmitter 204, or sensors that detect and/or process electromagnetic radiation transmitted by the location transmitter 202.

The computing device 110 may include a camera 406. The camera 406 may receive and/or process visible light input, and/or electromagnetic radiation in the visible light spectrum, to determine a location of the electronic stylus 100. The camera 406 may include features and/or functionalities of the camera 116 shown and described above with respect to FIG. 1.

The computing device 110 may include at least one infrared sensor 408. The infrared sensor 408 may received and/or process electromagnetic radiation in the infrared spectrum. In an example in which the electronic stylus 100 is used as a pointer and radiates an infrared beam (shown in FIG. 5), the infrared sensor 408 may receive and/or process the infrared beam. The computing device 110 may determine a location of the electronic stylus 100, a direction and/or orientation of the electronic stylus 100, and/or a location on the display 112 at which the electronic stylus 100 is pointing, based on the infrared beam.

The computing device 110 may include a stylus signal receiver 410. The stylus signal receiver 410 may receive signals from the electronic stylus 100 which indicate and/or include data and/or determinations received and/or determined by the electronic stylus 100. The stylus signal receiver 410 may receive the signals from the electronic stylus 100 via a wireless interface or protocol, such as an IEEE 802.15 Bluetooth interface or protocol. The signal receiver 410 may receive, for example, a color determined by the electronic stylus 100, audio input received and/or processed by the electronic stylus 100, touch input data received and/or processed by the electronic stylus 100, movement input data received and/or processed by the electronic stylus 100, and/or gestures determined by the electronic stylus 100.

The computing device 110 may include a stylus location determiner 412. The stylus location determiner 412 may determine a location of the electronic stylus 100. The stylus location determiner 412 may determine the location of the electronic stylus 100 based on data received by any of the sensors 404, such as the proximity sensor 405, camera 406, and/or infrared sensor 408. Applications, such as drawing applications, may use the locations determined by the location determiner 412 to modify the presentation on the display 112, such as by adding dots, lines, or strokes at the determined locations.

The computing device 110 may include a gesture determiner 414. The gesture determiner 414 may determine gestures based on input received from the electronic stylus 100 via the stylus signal receiver 410. The gesture determiner 414 may determine the gestures based on transmitted movement data received from the electronic stylus 100, such as input processed by the accelerometer 324 and/or gyroscope 326. The gestures may be recognized as mouse clicks, keyboard characters, or commands, according to example implementations.

The computing device 110 may include a color determiner 416. In an example in which the electronic stylus 100 determines the color attribute based on input to the electronic stylus 100, the color determiner 416 may determine the color based on a signal received from the electronic stylus 100 via the stylus signal receiver 410. In an example in which the computing device 110 determines the color attribute, the color determiner 416 may determine the color based on input into the computing device 110, such as a click on a color within a color palette or a predetermined input into a keyboard of the computing device 110. The computing device 110 may modify the presentation at the display 112 to the determined color at the location of the electronic stylus 100, such as by adding marking 118 of the determined color following a path of the electronic stylus 100.

The computing device 110 may include a tool selector 418. In an example in which the electronic stylus 100 determines the tool type attribute based on input to the electronic stylus 100, the tool selector 418 may determine the tool type based on a signal received from the electronic stylus 100 via the stylus signal receiver 410. In an example in which the computing device 110 determines the tool type attribute, the tool selector 418 may determine the tool type based on input into the computing device 110, such as a click on a tool icon or a predetermined input into a keyboard of the computing device 110. The computing device 110 may modify the presentation at the display 112 based on the selected tool type, such as adding marking 118 similar to a pen or pencil stroke or a paint brush.

The computing device 110 may include an authorizer 420. The authorizer 420 may determine whether to authorize a user to use the electronic stylus 100. The authorizer 420 may determine whether to authorize the user based on comparing a fingerprint detected by the fingerprint sensor 322 to a fingerprint stored in a database, based on comparing a combination of touches received by the touch sensor 320 to a combination of touches stored in a database, or other authorization techniques. If the authorizer 420 determines that the user is authorized, then the authorizer 420 may instruct the authorizer 338 and/or activator 340 to activate the electronic stylus 100 and/or allow the user to use the electronic stylus 100. The activator 340 may cause the electronic stylus 100 to activate in response to the fingerprint sensor 322 and/or authorizer 420 recognizing the fingerprint of the authorized user.

The computing device 110 may include a signal transmitter 422. The signal transmitter 422 may transmit signals to the electronic stylus 100, such as attribute signals including color signals indicating a determined color and/or tool signals indicating a determined tool type, and/or authorization signals authorizing the user. The signal transmitter 422 may transmit signals to the electronic stylus 100 via a wireless interface or protocol, such as IEEE 802.15 Bluetooth.

The computing device 110 may include at least one processor 424. The at least one processor 424 may execute instructions, such as instructions stored in memory, to cause the computing device 110 to perform any combination of methods, processes, or functions described herein.

The computing device 110 may include at least one memory device 426. The at least one memory device 426 may include a non-transitory computer-readable storage medium storing instructions and data. The instructions, when executed by the at least one processor 424, may be configured to cause the computing device 110 to perform any combination of methods, processes, or functions described herein. The data may include any data received by any of the stylus signal receiver 410 and/or input/output nodes 428, transmitted by the signal transmitter 422, and/or generated or acted upon by any component of the computing device 110.

The computing device 110 may include input/output nodes 428. The input/output nodes 428 may include multiple input nodes and multiple output nodes. The multiple input nodes may include a touchscreen included in the display 112, camera and/or infrared sensor(s), a wireless interface for receiving signals from the electronic stylus 100, and/or a wireless interface for receiving signals from other computing devices such as an IEEE 802.15 Wireless Local Area Network (WLAN) interface. The multiple output nodes may include the display 112 presenting graphical output, a wireless interface for sending signals to the electronic stylus 100, and/or a wireless interface for sending signals to other computing devices such as an IEEE 802.15 WLAN interface.

FIG. 5 shows the electronic stylus 100 projecting an optical beam 502 onto the computing device 110 according to an example implementation. The display 112 of the computing device 110 may rest upright on a stand 504 in an example in which the computing device 110 is a tablet or slate computing device, may be held upright by a base in the example of a laptop or notebook computing device, or may be held upright by a stand in an example of a desktop computing device.

In this example, the electronic stylus 100 may include an optical transmitter 202A. The optical transmitter 202A may be included in the location transmitter 202, or may be a separate component of the electronic stylus 100. The optical transmitter 202A may project a signal onto the display in a direction parallel to an extension of the housing 200, such as by transmitting a narrow optical beam 502 to the display 112. The optical beam 502 may be in an infrared spectrum, which is unidirectional and not visible to persons but can be detected by the computing device 110. The computing device 110 may be able to recognize the signal projected by the optical transmitter 202A to detect the location and/or orientation of the electronic stylus 100, and/or a location 506 on the display 112 at which the electronic stylus 100 is pointing, from distances between the electronic stylus 100 and computing device 110 of at least one foot, based on the optical beam 502. The user may use the electronic stylus 100 as a virtual laser pointer, and the computing device 110 may present a dot or other icon at the location 506 on the display 112 at which the electronic stylus 100 is pointing.

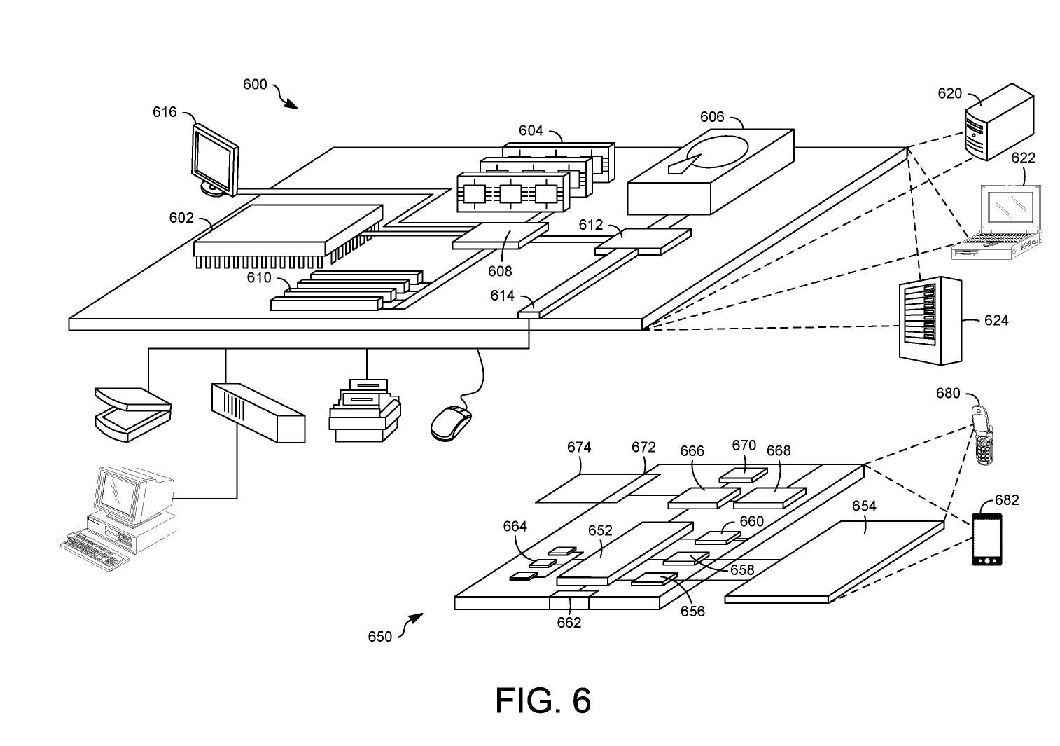

FIG. 6 shows an example of a generic computer device 600 and a generic mobile computer device 650, which may be used with the techniques described here. Computing device 600 is intended to represent various forms of digital computers, such as laptops, desktops, tablets, workstations, personal digital assistants, televisions, servers, blade servers, mainframes, and other appropriate computing devices. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. The processor 602 can be a semiconductor-based processor. The memory 604 can be a semiconductor-based memory. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. An electronic stylus comprising:
a location transmitter configured to prompt a computing device to modify a presentation on a display of the computing device at a location near the electronic stylus;
an indicator, the indicator being configured to indicate an attribute of a tool used to modify the presentation on the display at the location near the electronic stylus; and
a housing supporting the location transmitter and the indicator,
wherein the location transmitter and the indicator are included on a conical end portion of the housing.

2. (canceled)

3. The electronic stylus of claim 1, wherein the indicator is adjacent to the location transmitter.

4. (canceled)

5. The electronic stylus of claim 1, wherein the indicator is configured to indicate a color to which the presentation on the display will be modified near the location of the electronic stylus.

6. The electronic stylus of claim 1, further comprising:
a receiver configured to receive, from the computing device, a signal indicating a color to which the display is modified near the electronic stylus,
wherein the indicator is configured to indicate the color indicated by the signal received from the computing device.

7. The electronic stylus of claim 1, further comprising:
a touch sensor supported by the housing;
an attribute selector configured to select an attribute to which the presentation on the display is modified based on input to the touch sensor; and
an attribute transmitter supported by the housing, the attribute transmitter being configured to transmit the selected attribute to the computing device,
wherein the indicator is configured to indicate the attribute selected by the attribute selector.

8. The electronic stylus of claim 1, wherein:
the indicator comprises a multicolor touch sensor supported by the housing, the multicolor touch sensor concurrently displaying multiple colors at multiple locations on the multicolor touch sensor;
the electronic stylus further comprises an attribute selector configured to select a color to which the presentation on the display is modified based on input to the multicolor touch sensor at one of the multiple locations on the multicolor touch sensor that displays the selected color; and
the electronic stylus further comprises an attribute transmitter supported by the housing, the attribute transmitter being configured to transmit the selected color to the computing device,
wherein the indicator is configured to change an appearance of one of the displayed multiple colors based on the attribute selector selecting the color.

9. The electronic stylus of claim 1, further comprising:
a touch sensor supported by the housing;
a touch transmitter configured to transmit touch input data from the touch sensor to the computing device; and
a receiver configured to receive, from the computing device, a signal indicating a color to which the presentation on the display is modified, the computing device determining the color based on the transmitted touch input data,
wherein the indicator is configured to indicate the color indicated by the signal received from the computing device.

10. The electronic stylus of claim 1, further comprising:
a touch sensor supported by the housing;
a touch transmitter configured to transmit touch input data from the touch sensor to the computing device;
a receiver configured to receive, from the computing device, a signal indicating a color to which the presentation on the display is modified and a type of tool which is modifying the presentation on the display, the computing device determining the type of tool based on the transmitted touch input data; and
a tool displayer configured to display an icon representing the type of tool,
wherein the indicator is configured to indicate the color indicated by the signal received from the computing device.

11. The electronic stylus of claim 10, wherein the tool displayer is included in the indicator.

12. The electronic stylus of claim 10, wherein:
the electronic stylus further comprises an eraser transmitter located at an opposite end portion from the location transmitter, the eraser transmitter being configured to prompt the computing device to erase marking on the display at a location near the eraser transmitter.

13. The electronic stylus of claim 1, wherein the location transmitter is configured to project a signal onto the display in a direction parallel to an extension of the housing, the signal being recognized by the computing device from a distance of at least one foot.

14. The electronic stylus of claim 1, further comprising:
a microphone configured to receive audio input; and
an audio transmitter configured to transmit the audio input to the computing device.

15. The electronic stylus of claim 1, further comprising:
a fingerprint sensor configured to recognize a fingerprint of an authorized user,
wherein the electronic stylus is configured to activate in response to the fingerprint sensor recognizing the fingerprint of the authorized user.

16. The electronic stylus of claim 1, further comprising:
a touch sensor supported by the housing;
a touch transmitter configured to transmit touch input data from the touch sensor to the computing device;
a receiver configured to receive, from the computing device, a signal indicating that a user is authorized to use the electronic stylus based on the transmitted touch input; and
an activator configured to activate the location transmitter based on the signal indicating that the user is authorized to use the electronic stylus.

17. The electronic stylus of claim 1, further comprising:
an accelerometer supported by the housing; and
a movement transmitter configured to transmit movement data from the accelerometer to the computing device, the computing device recognizing a gesture based on the transmitted movement data.

18. The electronic stylus of claim 1, further comprising:
a gyroscope supported by the housing; and
a movement transmitter configured to transmit movement data from the gyroscope to the computing device, the computing device recognizing a gesture based on the transmitted movement data.

19. The electronic stylus of claim 1, further comprising:
an accelerometer supported by the housing;
a gyroscope supported by the housing;
a pressure sensor supported by the housing; and
a movement transmitter configured to transmit movement data from the accelerometer and the gyroscope to the computing device beginning at a time at which input to the pressure sensor changed, the computing device recognizing a gesture based on the transmitted movement data.

20. The electronic stylus of claim 1, further comprising:
a touch sensor supported by the housing; and
a touch transmitter configured to transmit touch input data from the touch sensor to the computing device, the computing device recognizing a gesture based on the transmitted touch input data.

21-24. (canceled)

25. An electronic stylus comprising:
a location transmitter configured to prompt a computing device to modify a presentation on a display of the computing device at a location near the electronic stylus;
an indicator, the indicator being configured to indicate an attribute of a tool used to modify the presentation on the display at the location near the electronic stylus, the indicator being adjacent to the location transmitter; and
a housing supporting the location transmitter and the indicator.

26. The electronic stylus of claim 25, further comprising an eraser transmitter located at an opposite end portion from the location transmitter, the eraser transmitter being configured to prompt the computing device to erase marking on the display at a location near the eraser transmitter.

27. An electronic stylus comprising:
a location transmitter configured to prompt a computing device to modify a presentation on a display of the computing device at a location near the electronic stylus;
a multicolor touch sensor configured to concurrently display multiple colors at multiple locations on the multicolor touch sensor and to change an appearance of one of the displayed multiple colors based on a selection of one of the displayed multiple colors;
a color selector configured to select a presentation color to which the presentation on the display is modified based on input to the multicolor touch sensor at one of the multiple locations on the multicolor touch sensor that displays the selected display color;
a color transmitter configured to transmit the selected display color to the computing device; and
a housing supporting the location transmitter and the multicolor touch sensor.

28. The electronic stylus of claim 27, further comprising an eraser transmitter located at an opposite end portion from the location transmitter, the eraser transmitter being configured to prompt the computing device to erase marking on the display at a location near the eraser transmitter.
